(19) United States
(12) Patent Application Publication
(10) Pub. No.: US 2007/0035846 A1
(43) Pub. Date: Feb. 15, 2007

(54) Method and apparatus for attaching microdisplays and other sensitive devices

(75) Inventors: Scott Detro, Los Altos, CA (US); Greg Felix, San Jose, CA (US)

Correspondence Address: SCOTT DETRO, 872 MANOR WAY, LOS ALTOS, CA, 94024, US

(73) Assignee: Scott Detro and Greg Felix

(21) Appl. No.: 11/203,014

(22) Filed: Aug. 11, 2005

(51) Int. Cl. G02B 27/14

(52) U.S. Cl. 359/634

(57) ABSTRACT

A frame, termed a prism frame, is attached to a processing face of a prism assembly and used to hold a position of a compensating waveplate and a microdisplay. The compensating waveplate includes adjustment tabs that allow precise positioning of an orientation of the waveplate (e.g., waveplate angle, rotation, etc) such that it is best positioned to compensate for items like residual retardation and/or skew rays that occur in the kernel. The precise position is varied depending on kernel design and other factors. A microdisplay frame is attached to a microdisplay package. The microdisplay frame is then precisely attached to the prism frame. The microdisplay can be removed from the kernel by sacrificing the inexpensive microdisplay frame.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to the attachment of microdisplays and other sensitive devices to prism assemblies or other components.

2. Discussion of Background

Light Engines are utilized in optical devices, particularly projection video devices, and generally comprises a light source, condenser, kernel, projection lens, and a display screen, and related electronics. The function of the components of an LCOS based video projector 100 is explained by example of a light engine with reference to FIG. 1. As shown, white light 110 is generated by a light source 105. The light is collected, homogenized, polarized, and formed into the proper shape and otherwise processed by optics (not all shown for clarity). The light then enters a prism assembly 150 where it is broken into red, green and blue polarized light beams. A set of reflective microdisplays 152A, 152B, and 152C are provided and positioned to correspond to each of the polarized light beams (the prism assembly 150 with the attached microdisplays is called a kernel). The beams then follow different paths within the prism assembly 150 such that each beam is directed to a specific reflective microdisplay. The microdisplay that interacts with (reflects) the green beam modulates the green content of a full color video image. Similarly, the red and blue contents of the full color image are modulated by corresponding “red” and “blue”microdisplays. The prism assembly 150 then recombines the modulated beams into a modulated white light beam 160 that contains the full color video image. The resultant modulated white light beam 160 then exits the prism assembly 150 and enters a projection lens 165. Finally, the image-containing beam (white light beam 160 has been modulated and now contains the full color image) is projected onto a screen 170.

Many different prism assemblies are commercially available in many varying configurations. However, the kernel is generally the optical heart of the light engine. The kernel is composed of the prism assembly and at least one, and typically three LCOS microdisplays.

The microdisplays are generally attached to the prism assembly. The attachment may be implemented, for example, via a six-axis adjustment device that allows the microdisplay to be placed in precise optical alignment. In certain advanced prism assembly designs, the attachment may be more permanent and direct.

### SUMMARY OF THE INVENTION

The present inventors have realized the need for more efficient and flexible mounting systems and method for attaching microdisplays, such as Liquid Crystal On Silicon (LCOS) microdisplays and other sensitive devices. The attachments are, for example, to a prism assembly in constructing a kernel for a light engine. In one embodiment, the present invention provides a device, comprising, a prism frame, a microdisplay package; and a compensation waveplate fixed in the prism frame at an orientation relative to a reference axis, wherein the microdisplay package is fixed to the prism frame such that a plane of a pixel array of the microdisplay is parallel to a reference plane.

The present invention also includes a method, comprising the steps of, attaching a prism frame to a prism assembly, inserting a compensation waveplate in a prism frame, attaching a microdisplay and frame package to the prism frame, and fixing the compensation waveplate to the prism frame in an orientation relative to a reference axis.

Various details and options of the devices and methods of the present invention are described in detail below.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of a generic Liquid Crystal on Silicon (LCOS) light engine;

FIG. 2 is a drawing of an exploded view of an attachment mechanism for a microdisplay and related optics according to an embodiment of the present invention;

FIG. 3 is a flow chart describing an attachment method according to an embodiment of the present invention;

FIG. 4 is a drawing of two prism frames attached to a prism assembly according to an embodiment of the present invention;

FIG. 5 is a drawing of a pair of compensation frames and compensation waveplates within two prism frames according to an embodiment of the present invention;

FIG. 6 is a drawing of a commercially available microdisplay package and a microdisplay frame according to an embodiment of the present invention;

FIG. 7 is a drawing of two views of a microdisplay package attached to a microdisplay frame according to an embodiment of the present invention;

FIG. 8 is a drawing of a pair of microdisplays attached to a kernel according to an embodiment of the present invention;

FIG. 9 is a detail drawing of a compensation device (compensation waveplate inserted in a prism frame according to an embodiment of the present invention;

FIG. 10 is an exploded view diagram of an attachment mechanism for a microdisplay and related optics according to an embodiment of the present invention;

FIG. 11 is a drawing of a prism frame attached to a prism assembly according to an embodiment of the present invention;

FIG. 12 is a drawing of a compensation frame and compensation waveplate within a prism frame according to an embodiment of the present invention;

FIG. 13 is a drawing of a commercially available microdisplay package and a microdisplay frame according to an embodiment of the present invention;

FIG. 14 is a drawing of two views of a microdisplay package attached to a microdisplay frame according to an embodiment of the present invention; and

FIG. 15 is a drawing of a pair of microdisplays attached to a kernel according to an embodiment of the present invention.

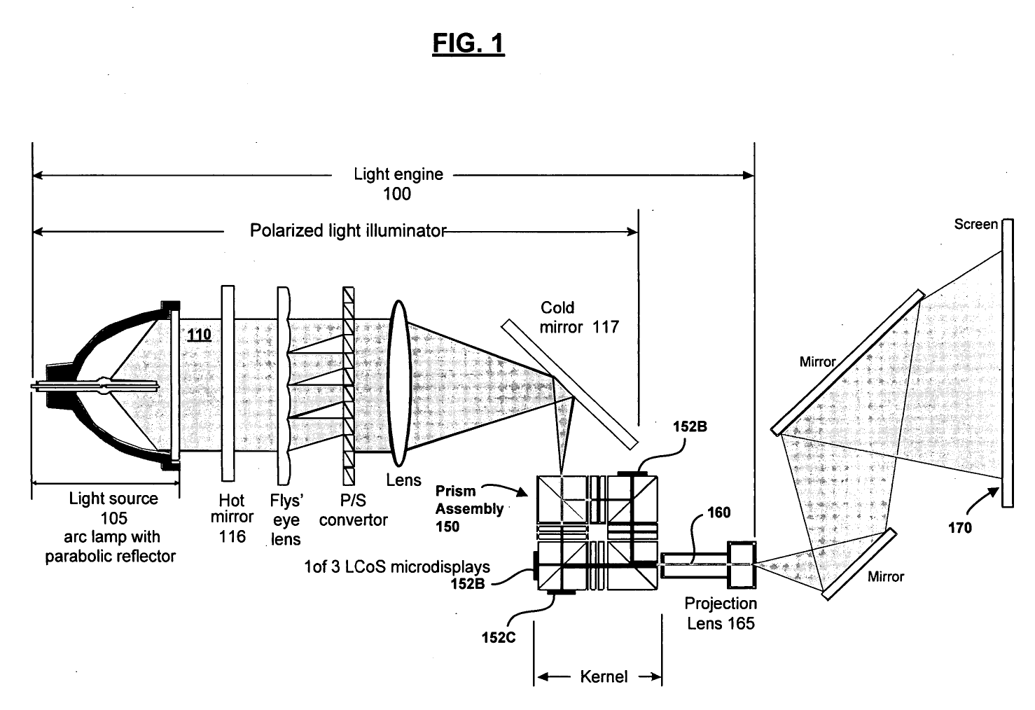

### DESCRIPTION OF THE PREFERRED EMBODIMENTS

A light engine such as those used in a Rear Projection Television (RPTV) or other projection devices, generally include a kernel having a combination of optics and modulation devices to modulate a light beam with an image. The kernel includes, for example, red, green, and blue color channels, and corresponding “red,” “green” and “blue” microdisplays. Several devices for attaching the microdisplays to the optics are described in Berman et al., U.S. Pat. No. 6,796,663, issued Oct. 26, 2004, and entitled “Method and Apparatus for Mounting Liquid Crystal on Silicon (LCOS) and Other Sensitive Devices,” and Detro et al., U.S. patent application Ser. No. 11/007,767,” filed Dec. 7, 2004, entitled “Prism Assembly Construction for Improved. Projection Systems the contents of which are incorporated herein by reference in their entirety.

The present inventors have realized improved methods and devices for attaching microdisplays (e.g., reflective LCOS microdisplays). The improved methods and devices may also be applied to mounting other sensitive optics, electronics, etc. In general, the improved devices and methods are preferably applied to producing a single piece monolithic kernel, where optics and positioning of microdisplays are fixed in position and non adjustable after mounting.

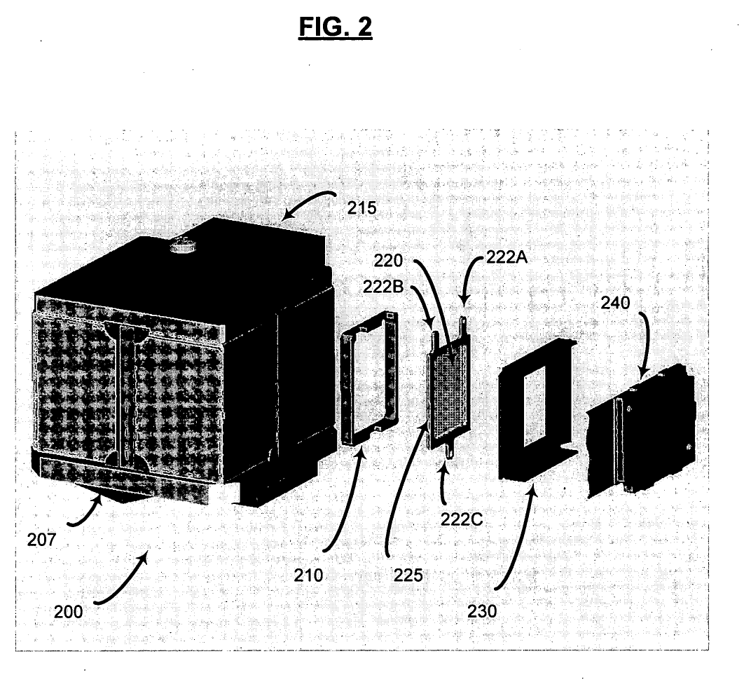

The lms-AT kernel is an example of a monolithic kernel, a kernel that is path length matched where all microdisplays are permanently and non-adjustably mounted to the kernel's prism assembly. The lms-AT kernel is constructed with a prism assembly in which pathlength matched beam splitters are set in kernel or prism assembly pathlength matched positions and coupled with an index matching fluid. An expansion device (e.g., 215, FIG. 2) comprising, for example, a diaphragm that flexes to compensate for expansion/contraction of the coupling fluid and/or the prism assembly.

Desirable features of an attachment device and or an attachment method include that it: connect to the microdisplay in a way that is mechanically/thermally stable, and dimensionally predictable; connect to the prism assembly in a way that is mechanically/thermally stable and dimensionally predictable; mask the area outside the active array of the microdisplay; hold and allow precise adjustment of the compensation material and also allow for properly oriented material to be stably fixed in place; be adaptable to a variety of microdisplays, including those that are currently commercially available.

Additional desirable features include that it: allows for simple and high yielding rework of the kernel should rework be found necessary. More specifically allow reclamation of the expensive microdisplays, compensation and prism assembly; not reduce the sequential or ANSI contrast ratio of the image projected by the kernel; be physically compact; be inexpensive; be simple to implement in a high volume manufacturing environment; be reliable. That is, kernels using attachment according to the present invention must pass all reliability tests; not generate dust during the attachment process; and not allow the accumulation of dust during operation of a device using kernel (e.g., an HDTV).

The present invention is an advance in the state of the art of microdisplay attachment. The invention is described with reference to two different commercially available microdisplays or microdisplay packages, and, as will be apparent to the ordinarily skilled artisan after review of the present invention, the methods and devices presented may be extended to other microdisplays.

Referring again to the drawings, wherein like reference numerals designate identical or corresponding parts, and more particularly to FIG. 2 thereof, there is illustrated an exploded view of an attachment mechanism and related optics according to an embodiment of the present invention. The main components of the attachment mechanism are a prism frame 210, a compensation device 220, a compensation frame 225, a microdisplay frame 230, and a microdisplay package 240. The microdisplay package is, for example, that utilized in Aurora Systems′ microdisplay.

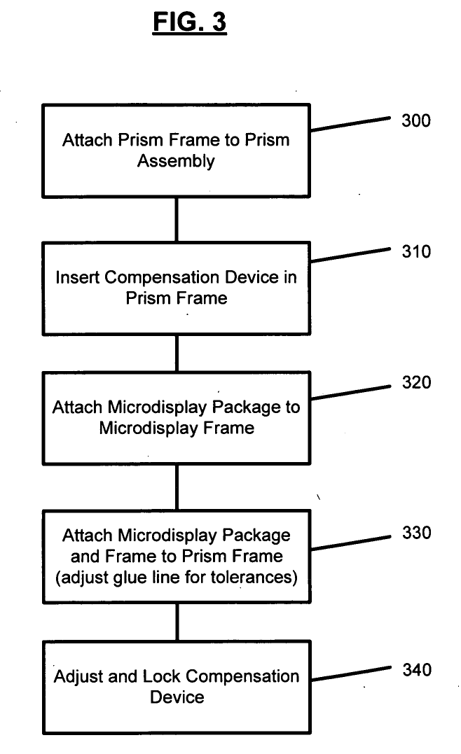

FIG. 3 is a flow chart illustrating attachment methods according to embodiments of the present invention. At step 300, the prism frame (e.g. prism frame 210) is attached to a prism assembly. The prism frame 210 is attached at a processing face of the prism assembly. The processing face is a portion of the prism assembly which light to be modulated (e.g., red, green, or blue light) is directed by the optics of the prism assembly.

At step 310 a compensation device (e.g., compensation device 220 and compensation frame 225) are inserted into a prism frame. The compensation device 220 will eventually be fixed in a precise position in the prism frame 210. The fixed position is, for example, a permanent fixed position achieved by an adhesive that locks the position of the compensation device.

At step 320, a microdisplay package is attached to a microdisplay frame. The microdisplay frame provides a potentially sacrificial component to attach the microdisplay package to the prism frame (step 330) using, for example, an adhesive. The compensation device is fixed in position after the microdisplay is attached (step 340).

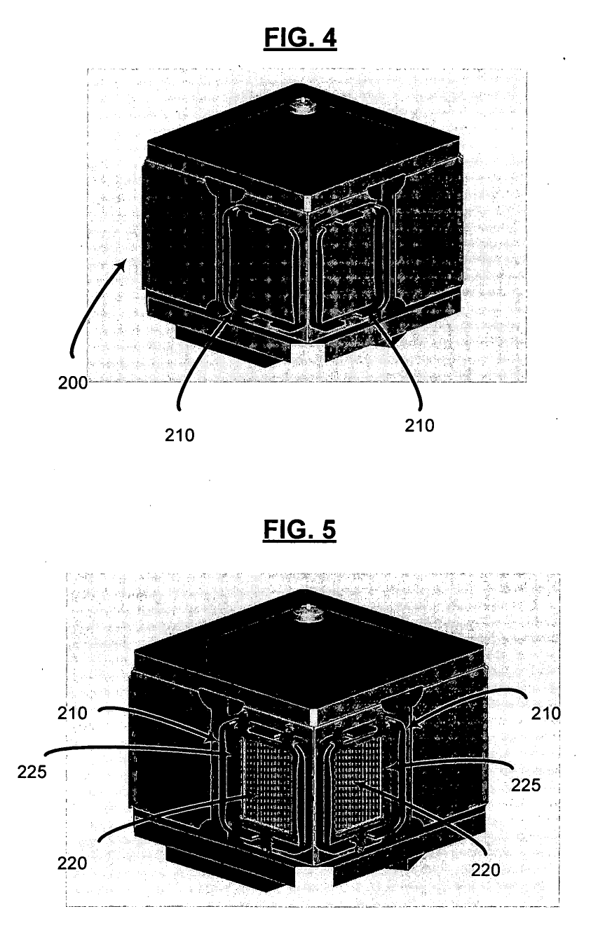

As shown in FIG. 4, 2 copies of frame 210 are rigidly attached to respective glass (processing) faces of a prism assembly 200. The prism frame. 210 is, for example, a walled enclosure abutted against a processing face of the prism assembly 200. The walled enclosure supports other optical elements (e.g., compensation device and microdisplay). And, FIG. 5 illustrates a compensation device 220 located within the prism frames 210.. The wall height of the prism frame, and the depth of notches are such that the oriented waveplate does not pass a top plane of the prism frame (preventing contact with the microdisplay package and/or frame). The notches themselves have a width that is sufficient to allow rotation of the waveplates without the adjustment tabs contacting the prism frame.

The compensation device 220 is, for example, a waveplate (e.g., quarter waveplate). A compensation frame 225 is attached to compensation device 220. The compensation frame 225, for example, surrounds a perimeter of the compensation device. Alternatively, the compensation frame is configured to attach to selected portions of the compensation device. The compensation frame 225 includes adjustment tabs, for example, adjustments tabs 222A, 222B, and 222C (see FIG. 2).

As illustrated in FIG. 5, the compensation device 220 is inserted into the prism frame. The prism frame includes notches from which the adjustment tabs extend. The adjustment tabs are utilized to precisely position the compensation device.

Within the prism frame 210, the compensation frame 225 is designed to rotate to a certain degree about its optical axis. (Note that an apparatus attaches to the adjustment tabs and is used to precisely adjust the orientation of the compensation). Once the compensation is properly oriented, features on the compensation frame are then attached with a rigid adhesive to the prism frame thus locking in the orientation of the compensation. For example, the adjustment tabs themselves may be fixed via adhesive to the notches of the prism frame.

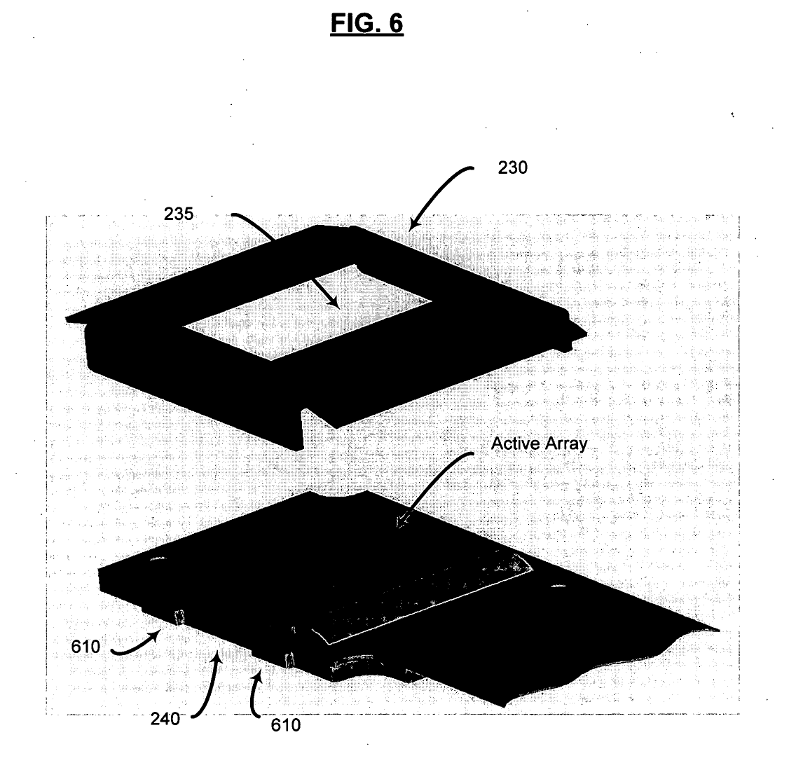

The microdisplay frame 230 is attached to a microdisplay package 240. The points of attachment of the microdisplay frame 230 are to features of the microdisplay package 240 that are mechanically stable with respect to the pixel array. The present invention takes advantage of reinforced portions of the microdisplay package to attach the microdisplay package to the microdisplay frame. For example, tabs 610 (see FIG. 6) are part of a stiffener portion of the microdisplay package that is the most rugged portion of the microdisplay.

FIG. 6 illustrates a microdisplay frame 230 and a microdisplay package 240. Dots of a rigid adhesive are applied to the points that attach the microdisplay frame 230 to the microdisplay package 240. For example, reinforced attachment points 610 of the microdisplay package are utilized for adhesive application. A balance of the microdisplay frame/microdisplay package perimeter is sealed using a more flexible adhesive. The perimeter seal along with other bond lines attaching the microdisplay frame/microdisplay package, serve to contain the optical surfaces of the prism assembly and the microdisplay and thus prevent the accumulation of dust.

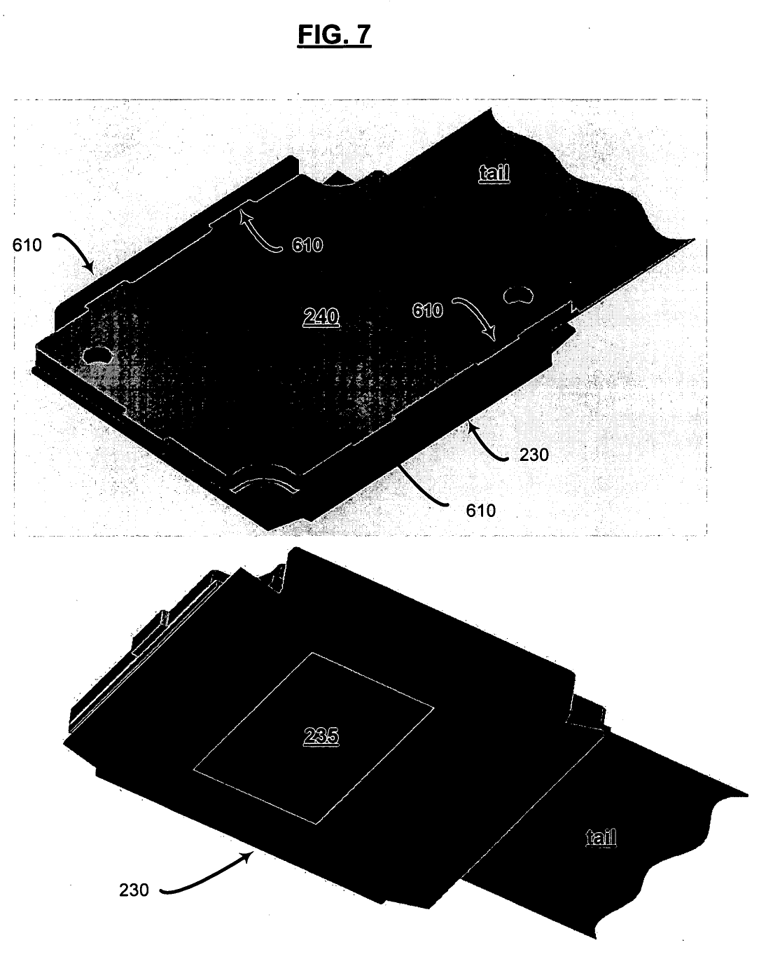

The microdisplay frame 230 has an aperture 235 that accurately masks the area outside the active array of the microdisplay. The material of the microdisplay frame is chosen to have a coefficient of thermal expansion similar to that of the microdisplay substrate. Two views of the microdisplay package 240 and attached microdisplay frame are illustrated in FIG. 7.

The microdisplay frame is bonded to the prism frame utilizing a thin layer of rigid adhesive.

The frame components may be blackened to reduce further propagation and/or generation of stray, reflected light.

If kernel rework is needed it is possible to pry and pop open the points of rigid adhesive attachment between the microdisplay frame and the microdisplay package. This allows removal and reclamation of the microdisplay. The microdisplay frame is then pealed or cleaved from the prism frame. The prism frame and compensation frame are not effected. Thus, in this procedure, the microdisplay frame may be destroyed (sacrificed) but all other components can be reclaimed.

There are several features of the means of attachment to be noted. In the Aurora microdisplay, the aperture in the microdisplay frame 130 is actively precisely aligned with the active array in the microdisplay. Active alignment comprises, for example, energizing perimeter pixels of the microdisplay and verifying that each pixel is visible through the aperture. Alternatively under magnification, without energization, the pixel array may be observed through the mask opening of the microdisplay frame and aligned mask.

Preferably, the compensation frame itself does not touch the prism frame. The reason is that, during the adjustment process, this minimizes the generation of particulate contamination. When the compensation frame is glued into the prism frame, no portion of the frames themselves are in contact.

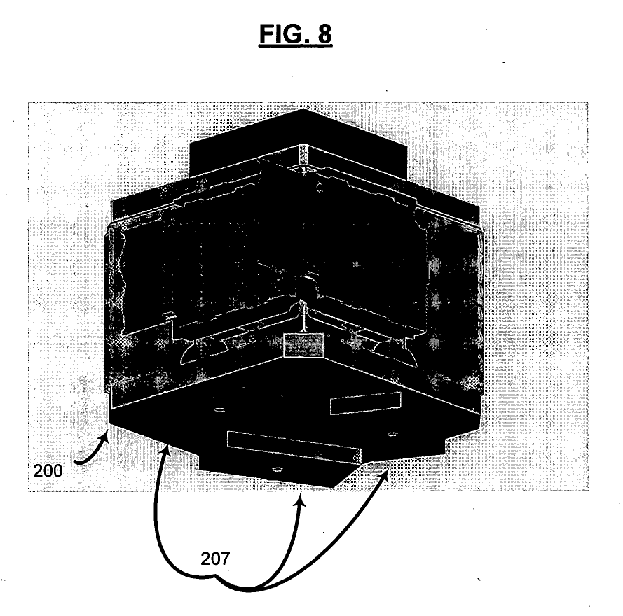

When the microdisplay frame is bonded to the prism frame, the orientation of the components is adjusted so as to assure that the prism face is within all tolerances (e.g., parallel to the microdisplay face and of a pathlength within required tolerances). Tolerance checks may be performed mechanically or via active processes prior to adhesive curing. The finished product is illustrated in FIG. 8 (in this design, a third microdisplay is attached on the opposite side of kernel 200. Feet 207 provide securing posts for mounting the kernel in a light engine. The light engine is part of an optical system used, for example, in a High Definition (HD) Television, projector, or similar apparatus.

The first microdisplay to be attached to the prism assembly is the green microdisplay. The thickness of the glue line between the microdisplay frame and the prism frame is set to a nominal of, for example, 75 microns. The red and blue microdisplays are then attached and the thickness of these glue lines are actively adjusted during the bonding process. The purpose of this procedure includes proper adjustment for the chromatic focal shift of the projection lens, and adjustment for minor variations in optics, microdisplay package sizes, and other tolerance issues. Other glue lines between the prism assembly and the microdisplay may also be utilized to effect tolerances and/or assure that a plane of the pixel array of the microdisplay is parallel to the processing face of the prism assembly (or perpendicular to a light channel modulated by the microdisplay).

During rework, the microdisplay frame is removed from the prism frame by application of a “peeling” force.

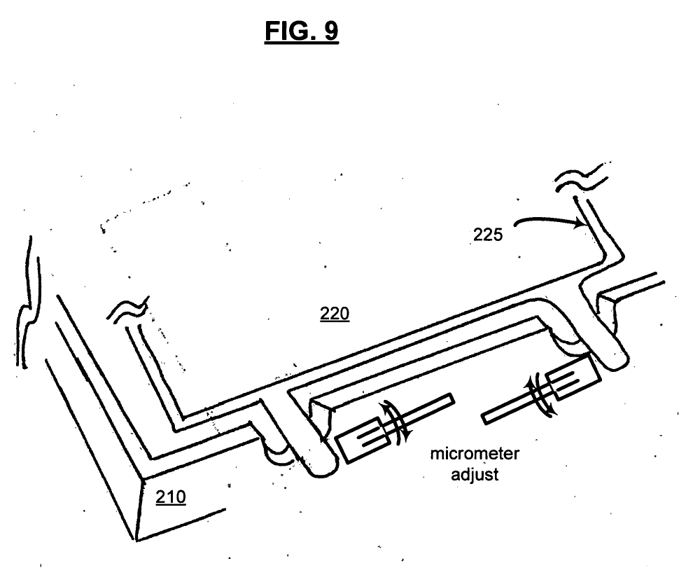

The compensation frame includes, for example, adjustment tabs 122A, 122B, and 122C that allow the compensation frame to be held in position and adjusted. For example, as illustrated in FIG. 9, two screw type positioning micrometers are shown contacting the adjustment tabs and which may be dialed in/out to provide for precise adjustment of an angular position of the compensation frame and compensation mechanism while within the prism frame 110. The micrometers are set, for example, on a stable platform (not shown) and level with the tabs.

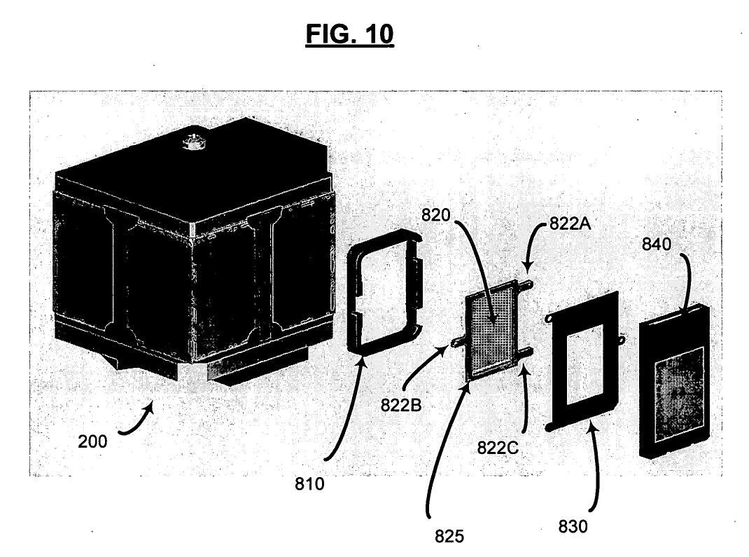

The adjustment tabs preferably include any mechanisms which are helpful in positioning or holding the frame and compensation device in a desired position and orientation. As shown in FIG. 2, the adjustment tab 222A includes a round hole near the end of the tab, the adjustment tab 222B includes a slot shaped hole near the end of tab 222B, and tab 222C is solid. The configuration of round hole, slotted hole, and solid tabs allows a kinematic positioning device to be utilized to position and hold the compensation frame in position during manufacture. A similar arrangement is shown in FIG. 10 with respect to tabs 822A, 882B, and 822C.

The compensation device 120 is, for example, a quarter wave plate rotated relative to an optical axis of light passing through the prism assembly face to which the prism frame is attached such as an axis of polarization. Alternatively, the axis is a residual retardation axis of the microdisplay. Both polarization and residual retardation axis may be utilized in determining the orientation of the compensation device.

Notches in the prism frame corresponding to each of the adjustment tabs allow the adjustment tabs to be held/positioned while in the prism frame without touching the prism frame. The compensation waveplate is precisely positioned after attaching the microdisplay package and microdisplay frame. The same adjustment tabs are used for positioning the compensation waveplate. The attached microdisplay is used in determining the precise position of the compensation waveplate (e.g., input light passing through the compensation waveplate, modulated, by the microdisplay with a test pattern and then viewed while the position of the compensation waveplate is precisely fixed. The fixing is, for example, an adhesive placed in the notches and contacting the adjustment tabs—permanently fixing the compensation waveplates position. The micrometers may adjust the waveplate from any fixed reference point.

FIG. 10 is an exploded view diagram of an attachment mechanism for a microdisplay 840 and related optics according to an embodiment of the present invention. The microdisplay 840 is, in this example, an eLCOS microdisplay. It is noted that the orientation of the eLCOS microdisplay is different from the previously described example. Fitting the invention to the eLCOS microdisplay is now described.

FIG. 11 is a drawing of two prism frames attached to a prism assembly. As shown in FIG. 11, two prism frames 810 are attached to processing faces of kernel 200.

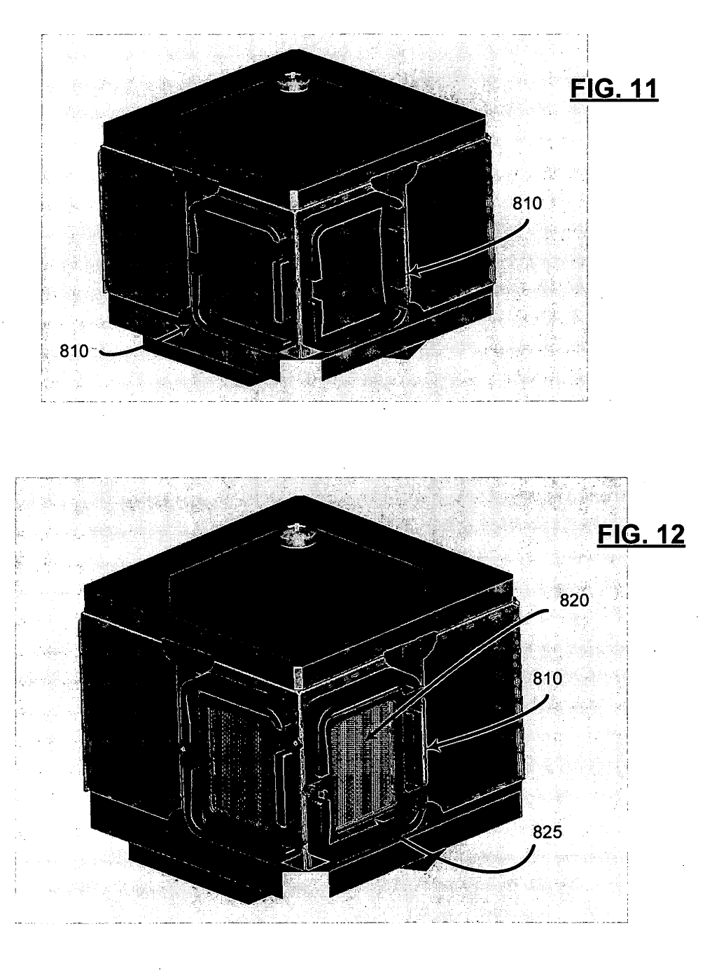

FIG. 12 is a drawing of a two compensation frames 825 and compensation waveplates 820 within prism frames 810. As shown in FIG. 12, the compensation waveplate fits entirely within the prism frame 810 and adjustment tabs 822A, 822B, and 822C of the compensation frame 825 extend into and beyond notches in the prism frame.

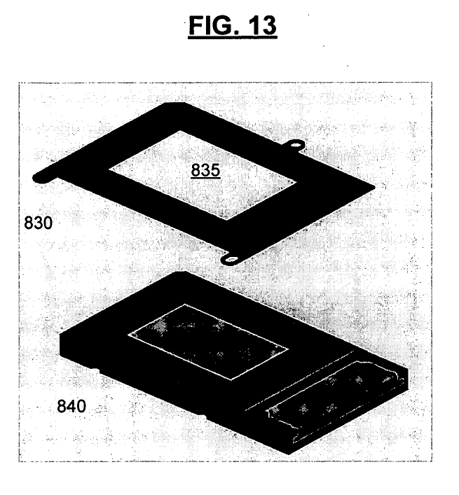

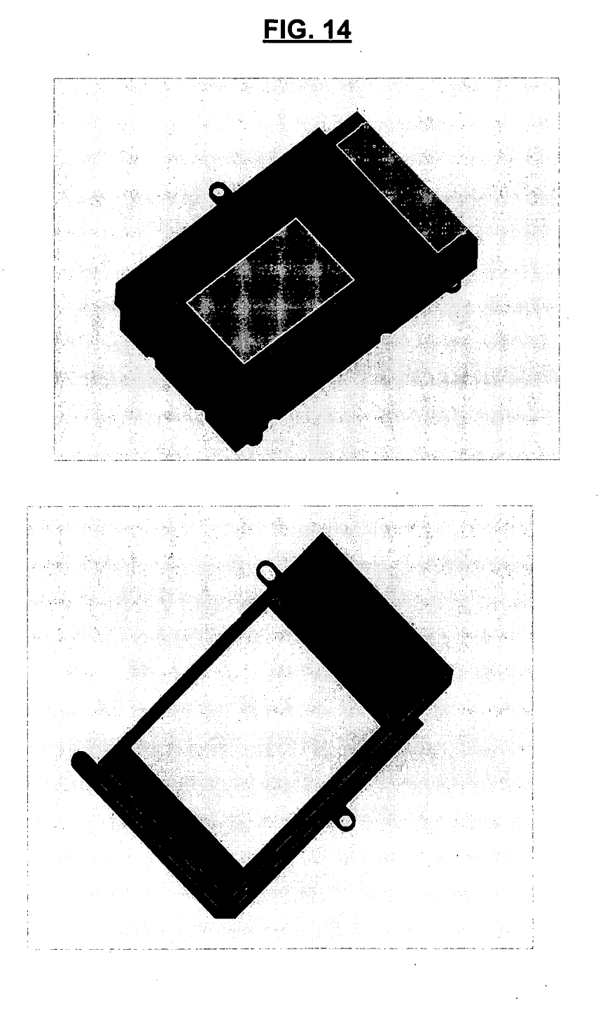

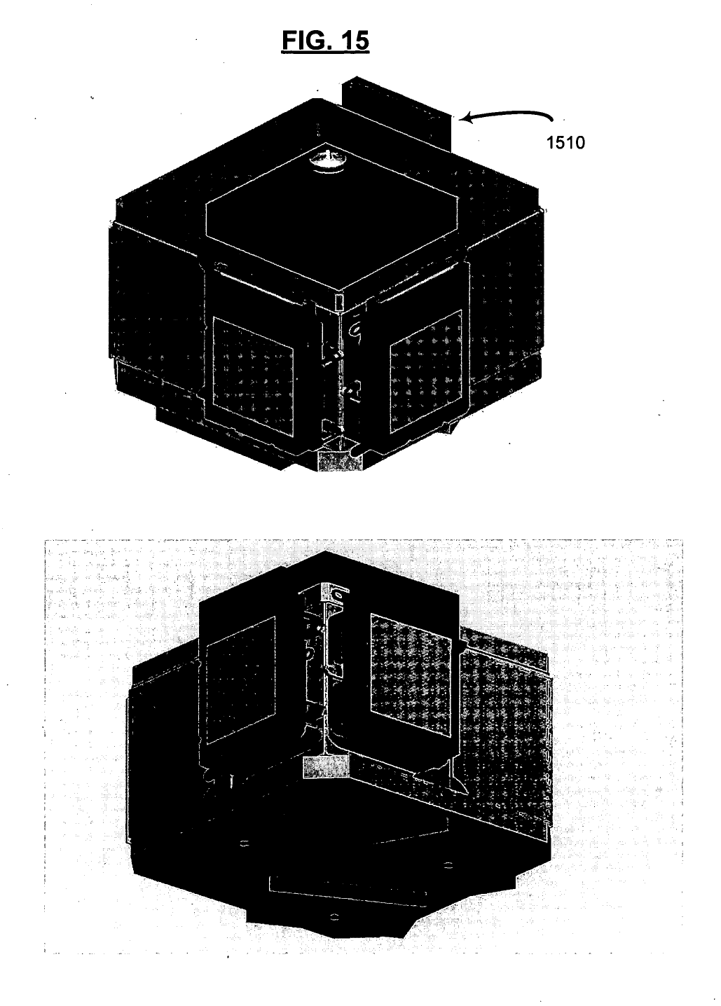

FIG. 13 is a drawing of a commercially available microdisplay package 840 and a microdisplay frame 830. The microdisplay package represents an eLCOS microdisplay. The microdisplay frame includes mask 835 that precisely matches the pixel array of the microdisplay 840. FIG. 14 is a drawing of two views of the microdisplay package 840 attached to the microdisplay frame 830. FIG. 15 is a drawing of a finished product, a pair of eLCOS microdisplays attached to a prism assembly/kernel. A third microdisplay 1510 is also attached to the prism assembly/kernel.

Although the present invention has mainly been described herein with reference to the lms-AT kernel, and two commercially available microdisplays, the devices and methods of the present invention may be applied to other kernels and microdisplays.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a frame (e.g., prism frame, microdisplay frame), notches, adjustment tabs, micrometers, any other equivalent device, or a device having an equivalent function or capability, whether or not listed herein, may be substituted therewith. Furthermore, the inventors recognize that newly developed technologies not now known may also be substituted for the described parts and still not depart from the scope of the present invention. All described items, including, but not limited to prism assemblies, kernels, microdisplays, frames, orientations, adhesives, tolerances, masks, sealants, waveplates, etc should also be considered in light of any and all-available equivalents.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

1. A device, comprising:
A prism frame;
a microdisplay package; and
a compensation waveplate fixed in the prism frame at an orientation relative to a reference axis;
wherein the microdisplay package is fixed to the prism frame such that a plane of-a pixel array of the microdisplay is parallel to a reference plane.

2. The device according to claim 1, wherein the reference axis is one of an axis of residual retardation of the microdisplay and an axis of polarization of light directed toward the pixel array.

3. The device according to claim 1, wherein the reference plane comprises a face of a prism assembly.

4. The device according to claim 1, wherein the orientation comprises an orientation that compensates for at least one of residual retardation of the microdisplay and skew rays of light directed toward the microdisplay.

5. The device according to claim 1, wherein the orientation comprises an angular rotation ø of the compensation waveplate; and the waveplate frame comprises a perimeter of a height sufficient to enclose the rotated compensation waveplate.

6. The device according to claim 1, wherein the compensation waveplate comprises a waveplate frame comprising at least one positioning appendage; and
the prism frame comprises at least one notch in which the at least one positioning appendage is disposed.

7. The device-according to claim 6, where the compensation waveplate is held in said orientation and at an angle to a plane of a pixel array of the microdisplay by securing the positioning appendages in the notches with adhesive.

8. The device according to claim 1, wherein the prism frame has a perimeter larger than a perimeter of the compensation waveplate.

9. The device according to claim 1, wherein the notches have a depth such that the compensation waveplate is oriented without passing a top plane of the prism frame.

10. The device according to claim 1, wherein the microdisplay package is fixed to the prism frame utilizing variations in glue line thickness to effect parallelism of the microdisplay to the reference plane.

11. The device according to claim 1, wherein:
the prism frame is attached- to a prism assembly of a kernel, and
the microdisplay package is fixed to the prism frame utilizing variations in glue line thickness to compensate for pathlength tolerances compared to at least one of other microdisplays of the kernel and chromatic focal shifts occurring in a light path of a system using the kernel-.

12. The device according to claim 11, wherein the system using the kernel is a Liquid Crystal On Silicon (LCOS) based High Definition (HD) Television.

13. The device according to claim 1, wherein a glue line contacting one of the prism frame; microdisplay frame, and microdisplay package accounts for placing a pixel array of the microdisplay within a tolerance of a light channel modulated by the microdisplay.

14. The device according to claim 1, wherein:
the device and two similar devices comprise first, second, and third light modulators mounted on processing faces of first, second and third light channels a prism assembly forming a kernel; and
each of the devices comprise glue lines of varying thicknesses that compensate for pathlength tolerances required for each of the light channels.

15. A method, comprising the steps of:
attaching a prism frame to a prism assembly;
inserting a compensation waveplate in the prism frame;
attaching a microdisplay package to the prism frame; and
fixing the compensation waveplate to the prism frame in an orientation relative to a reference axis.

16. The method according to claim 15, further comprising the step of adjusting a glue line between the prism assembly and the microdisplay package to compensate for pathlength tolerances of a light channel modulated by the microdisplay.

17. The method according to claim 16, wherein the step of adjusting the glue line is an active adjustment.

18. The method according to claim 15, wherein the step of attaching a microdisplay package comprises inserting the microdisplay package into a sacrificial frame and attaching the sacrificial frame to the prism frame.

19. The method according to claim 18, further comprising the step of adjusting a glue line between the prism assembly and the microdisplay package to compensate for pathlength tolerances of a light channel modulated by the microdisplay.

20. The method according to claim 19, wherein the glue line comprises one of a glue line between the prism frame and prism assembly, a glue line between the prism frame and the sacrificial frame, and a glue line between the sacrificial frame and the microdisplay package.

21. The method according to claim 15, wherein:
the microdisplay package comprises a reflective Liquid Crystal On Silicon (LCOS) microdisplay;
the microdisplay package is mounted in a microdisplay frame; and
the step of attaching the microdisplay package tot he prism frame comprises attaching the sacrificial frame to the prism frame.

22. The method according to claim 21, wherein the sacrificial frame comprises a mask having dimensions approximately equal to a size of a pixel array of the reflective LCOS microdisplay.

23. The method according to claim 16, wherein:
the compensation waveplate comprises a waveplate set in a frame having adjustment tabs extending therefrom;
the prism frame comprises a perimeter wall having notches; and
the step of inserting comprises inserting the compensation waveplate in the prism frame such that a portion of the adjustment tabs are disposed in the notches.

24. The method according to claim 16, wherein:
the step of fixing the compensation waveplate comprises,
using the adjustment tabs to place the compensation waveplate in the orientation, and
fixing the waveplate in the placed orientation using an adhesive.

25. The method according to claim 24, wherein the adhesive is adhered to the adjustment tabs and the notches.

26. The method according to claim 15, wherein:
the microdisplay package is a commercial off-the-shelf microdisplay package;
the method further comprising the step of placing the microdisplay package in a microdisplay frame; and
the step of attaching the microdisplay package comprises attaching the microdisplay frame to the prism frame.

27. The method according to claim 26, wherein:
the step of placing the microdisplay package in a microdisplay frame comprises,
securing the microdisplay package to the microdisplay frame via a rigid adhesive at portions of the microdisplay package and microdisplay frame, and
sealing a perimeter of the microdisplay package and microdisplay frame.

28. The method according to claim 27, wherein the portions of the microdisplay package where rigid adhesive is applied comprises portions of a stiffener of the microdisplay package.

29. The method according to claim 27, wherein the step of sealing comprises applying a flexible adhesive to the perimeter of the microdisplay package and microdisplay frame.

30. The method according to claim 15, wherein the step of attaching a microdisplay package to the prism frame comprises utilizing a glue line to effect tolerances of both pathlength matching and pixel array parallelism.

31. A Liquid Crystal On Silicon (LCOS) projection device, comprising:
a prism assembly; and
a set of LCOS microdisplays attached to the prism assembly,
wherein:
each LCOS microdisplay is attached to a processing face the prism assembly using an arrangement including a compensating waveplate set at an angle to compensate for at least one of skew rays in a light channel of the LCOS microdisplay and residual retardation of the LCOS microdisplay; and
a glue line between the processing face of the prism assembly and the LCOS microdisplay is utilized to set a tolerance of the LCOS projection device.

32. The LCOS projection device according to claim 31, wherein tolerance is a pathlength tolerance.

33. The LCOS projection device according to claim 31, wherein the tolerance is to assure the microdisplay perpendicular to a light channel the microdisplay modulates.

34. The LCOS projection device according to claim 31, wherein the LCOS projection is installed in a High Definition (HD) Television.
